(19) United States
(12) Patent Application Publication
(10) Pub. No.: US 2011/0260956 A1
(43) Pub. Date: Oct. 27, 2011

(54) ACTIVE MATRIX CONTENT MANIPULATION SYSTEMS AND METHODS

(75) Inventors: Alok Govil, Santa Clara, CA (US); Tsongming Kao, Sunnyvale, CA (US); Marc M. Mignard, San Jose, CA (US); SuryaPrakash Ganti, Los Altos, CA (US); Philip D. Floyd, Redwood City, CA (US); Manish Kothari, Cupertino, CA (US)

(73) Assignee: QUALCOMM MEMS Technologies, Inc., San Diego, CA (US)

(21) Appl. No.: 13/092,030

(22) Filed: Apr. 21, 2011

Related U.S. Application Data
(60) Provisional application No. 61/327,019, filed on Apr. 22, 2010.

(51) Int. Cl. G09G 3/34

(52) U.S. Cl. 345/84

(57) ABSTRACT

This disclosure provides systems, methods and apparatus for sharing image data between interconnected pixels in a display device. Some implementations of a display device may include an array of pixels, where each pixel includes a display element, a memory element, one or more data interconnect lines connecting the pixel to one or more other pixels, one or more switches positioned in one or more of the interconnect lines and one or more scroll data lines connected to one or more of the switches. Some implementations may enable scrolling of image data on a display without writing new image data to the display. Further, in some implementations, the display element may be an interferometric modulator (IMOD). Some other implementations may additionally include a display, a processor configured to communicate with the display and a memory device that is configured to communicate with the processor.

### CROSS-REFERENCE TO RELATED APPLICATIONS

This disclosure claims priority to U.S. Provisional Patent Application No. 61/327,019, filed Apr. 22, 2010, entitled “Active Matrix Content Manipulation Systems and Methods,” and assigned to the assignee hereof The disclosure of the prior application is considered part of, and is incorporated by reference in, this disclosure.

### TECHNICAL FIELD

This disclosure relates to display devices. More particularly, this disclosure relates to content manipulation systems and methods for active matrix display devices associated with electromechanical systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device including an array of pixels, wherein each pixel includes at least one of a display element and a memory element; one or more data interconnect lines connecting a first pixel to one or more other pixels; one or more switches positioned in one or more of the interconnect lines; and one or more scroll data lines connected to one or more of the switches. In some implementations, the display element can be an interferometric modulator. Other implementations may additionally include a display; a processor that is configured to communicate with the display, the processor being configured to process image data; and a memory device that is configured to communicate with the processor.

Another innovative aspect of the subject matter described in this disclosure can be implemented in a display device including means for connecting a first pixel to a target pixel; means for receiving image data from the first pixel at the target pixel; and means for displaying the image data with the target pixel. In some implementations, the means for receiving image data from the pixel at the target pixel can be one or more data interconnect lines. In further implementations, the means for displaying the image data with the target pixel can be a display element.

Another innovative aspect of the subject matter described in this disclosure can be implemented in a method of scrolling image data from a first pixel to a target pixel, which includes connecting the first pixel to the target pixel; receiving image data from the first pixel at the target pixel; and displaying the image data at the target pixel. Some implementations may additionally include receiving scroll mode data at the target pixel. Other implementations may include writing new data to the first pixel when the first pixel is on the edge of a scroll area.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows an example of a schematic circuit diagram illustrating a driving circuit array for an optical MEMS display device.

FIG. 3 shows an example of a schematic partial cross-section illustrating one implementation of the structure of the driving circuit and the associated display element of FIG. 2.

FIG. 4 shows an example of a schematic exploded partial perspective view of an optical MEMS display device having an interferometric modulator array and a backplate with embedded circuitry.

FIG. 5 shows an example diagram of scrolling image data on a display.

FIG. 6 shows an example of a circuit diagram of a pixel where adjacent pixels are interconnected to allow scrolling in the up, down, left and right directions.

FIGS. 7A and 7B show examples of image data for selected scroll areas of a display, including selected rows and columns, being scrolled.

FIG. 8 shows an example of a circuit diagram of a pixel where adjacent pixels are interconnected to allow scrolling in the up, down, left and right directions.

FIG. 9 shows an example of a method of scrolling image data from a first pixel to a target pixel.

FIGS. 10A and 10B show examples of system block diagrams illustrating a display device that includes a plurality of interferometric modulators.

FIG. 11 shows an example of a schematic exploded perspective view of an electronic device having an optical MEMS display.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Active matrix pixels may be augmented with additional circuitry to reduce power consumption while increasing functionality. For example, active matrix pixel circuits may be augmented with data interconnect lines so that adjacent pixels can send and receive image data to and from each other. The interconnection of adjacent pixels reduces the amount of new image data that needs to be written to the display during certain display operations, such as scrolling. Because writing new image data to the display consumes a significant amount of power, reducing the need to write new image data from outside of the display may reduce overall power consumption significantly. For example, when scrolling an entire display down, all of the image data on the display may be transferred via data interconnect lines to the adjacent pixel in the downward direction with the exception of a single row at the top. Accordingly, the number of rows of new image data written to the display is reduced significantly. Further, additional circuitry may be added to active matrix pixels with data interconnect lines to enable scrolling in a defined scroll area within the display area. In this case, interconnects may be used to leave pixels unchanged while other pixels in the display are scrolled.

Particular implementations of the subject matter described in this disclosure can be implemented to realize one or more of the following potential advantages. The primary advantage is reduction in power consumption by a display device. By sharing data between pixels within the display, the need to write new image data to the display is reduced during common usage tasks, such as scrolling. In such active matrix pixels, the aforementioned advantages can be applied to defined areas of the display in addition to the display as a whole, which may further reduce power consumption. Reducing power consumption of the display device can increase the overall battery life of the device in which the display is integrated, such as a mobile device. A second important advantage of particular implementations of the subject matter described in this disclosure is the ability to achieve a smooth scrolling function in the display device without requiring a high frame rate. Conventionally, achieving smooth scrolling requires the display system to achieve greater than 30 Hz frame rate (more likely about 60 Hz), where the full display is refreshed for each frame. Writing a full frame implies as many write operations to the display as the number of independent scan lines. The overall speed of operation is thus determined by the number of independent scan lines to write and the time it takes to write the data to a single scan line. Under particular implementations of the subject matter described in this disclosure, the content may be scrolled with a very small number of write operations to the display.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

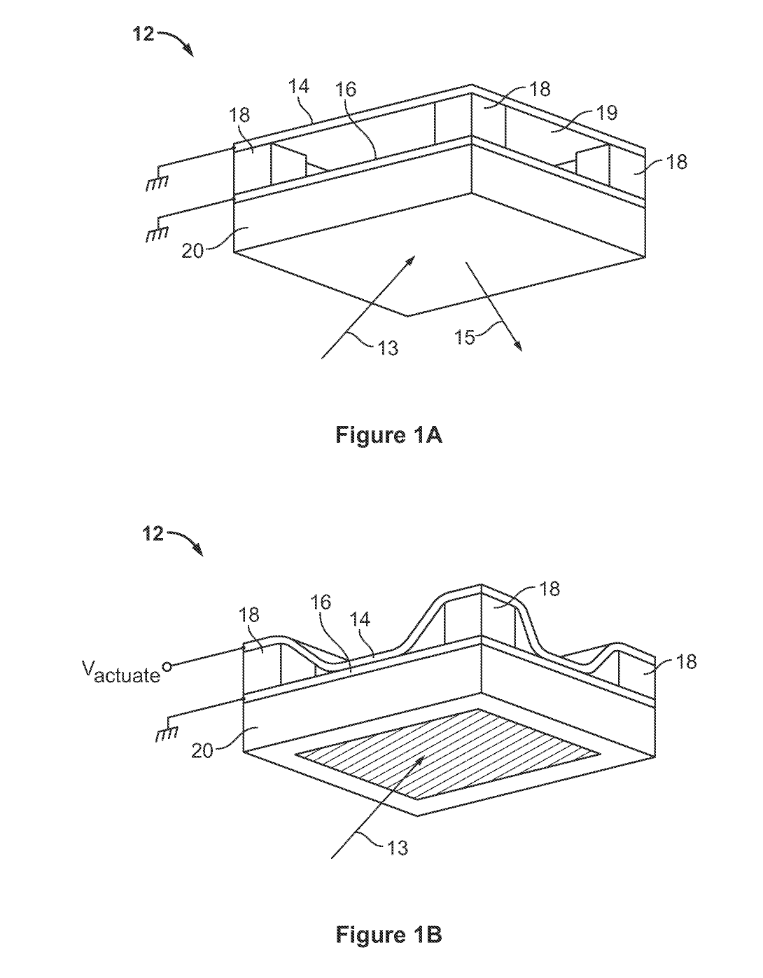

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 in FIG. 1A, a movable reflective layer 14 is illustrated in a relaxed position at a predetermined (e.g., designed) distance from an optical stack 16, which includes a partially reflective layer. Since no voltage is applied across the IMOD 12 in FIG. 1A, the movable reflective layer 14 remained in a relaxed or unactuated state. In the IMOD 12 in FIG. 1B, the movable reflective layer 14 is illustrated in an actuated position and adjacent, or nearly adjacent, to the optical stack 16. The voltage V_{actuate} applied across the IMOD 12 in FIG. 1B is sufficient to actuate the movable reflective layer 14 to an actuated position.

In FIGS. 1A and 1B, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the optical stack 16, or lower electrode, is grounded at each pixel. In some implementations, this may be accomplished by depositing a continuous optical stack 16 onto the substrate 20 and grounding at least a portion of the continuous optical stack 16 at the periphery of the deposited layers. In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 in FIG. 1A, with the gap 19 between the movable reflective layer 14 and optical stack 16. However, when a potential difference, e.g., voltage, is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, such as in a series or array of IMODs, the optical stacks 16 can serve as a common electrode that provides a common voltage to one side of the IMODs 12. The movable reflective layers 14 may be formed as an array of separate plates arranged in, for example, a matrix form. The separate plates can be supplied with voltage signals for driving the IMODs 12.

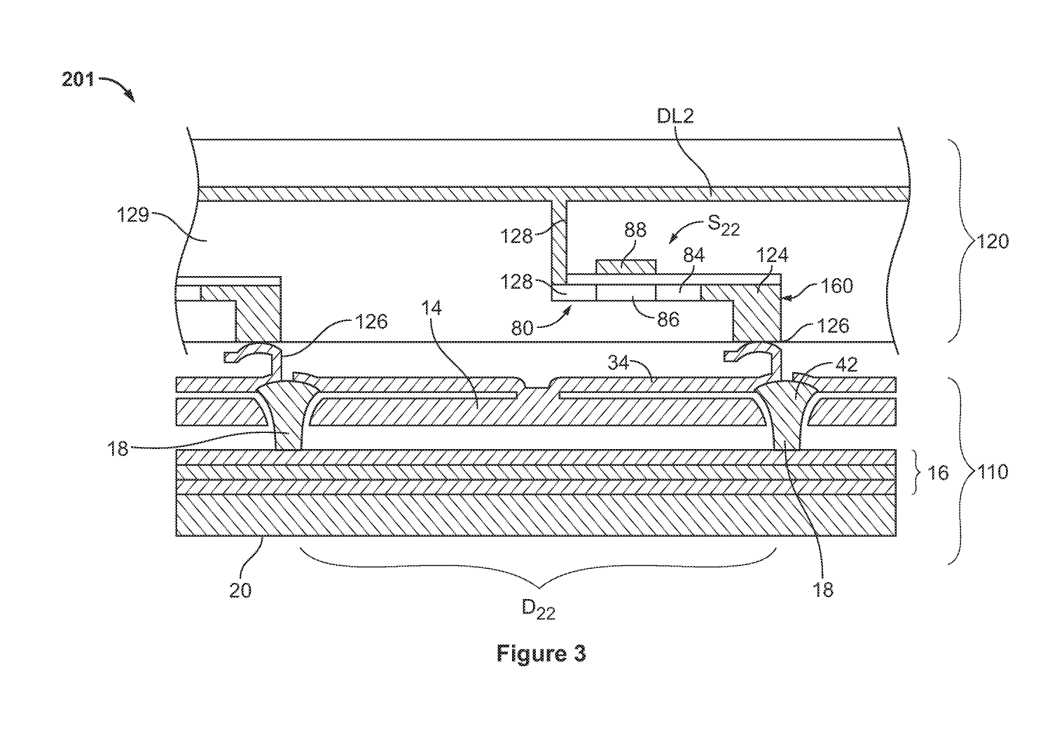

The details of the structure of interferometric modulators that operate in accordance with the principles set forth above may vary widely. For example, the movable reflective layers 14 of each IMOD 12 may be attached to supports at the corners only, e.g., on tethers. As shown in FIG. 3, a flat, relatively rigid movable reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the movable reflective layer 14 can be optimized with respect to the optical properties, and the structural design and materials used for the deformable layer 34 can be optimized with respect to desired mechanical properties. For example, the movable reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

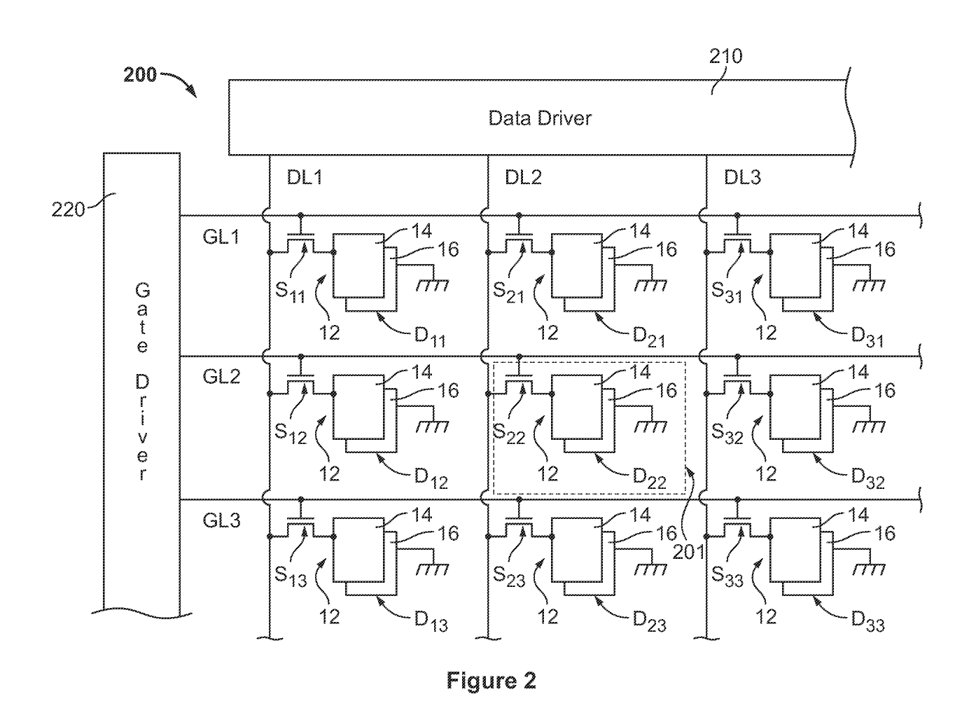

FIG. 2 shows an example of a schematic circuit diagram illustrating a driving circuit array 200 for an optical MEMS display device. The driving circuit array 200 can be used for implementing an active matrix addressing scheme for providing image data to display elements D11-Dmn of a display array assembly.

The driving circuit array 200 includes a data driver 210, a gate driver 220, first to m-th data lines DL1-DLm, first to n-th gate lines GL1-GLn, and an array of switches or switching circuits S11-Smn. Each of the data lines DL1-DLm extends from the data driver 210, and is electrically connected to a respective column of switches S11-S1n, S21-S2n, . . . , Sm1-Smn. Each of the gate lines GL1-GLn extends from the gate driver 220, and is electrically connected to a respective row of switches S11-Sm1, S12-Sm2, . . . , S1n-Smn. The switches S11-Smn are electrically coupled between one of the data lines DL1-DLm and a respective one of the display elements D11-Dmn and receive a switching control signal from the gate driver 220 via one of the gate lines GL1-GLn. The switches S11-Smn are illustrated as single FET transistors, but may take a variety of forms such as two transistor transmission gates (for current flow in both directions) or even mechanical MEMS switches.

The data driver 210 can receive image data from outside the display, and can provide the image data on a row by row basis in a form of voltage signals to the switches S11-Smn via the data lines DL1-DLm. The gate driver 220 can select a particular row of display elements D11-Dm1, D12-Dm2, . . . , D1n-Dmn by turning on the switches S11-Sm1, S12-Sm2, . . . , S1n-Smn associated with the selected row of display elements D11-Dm1, D12-Dm2, . . . , D1n-Dmn. When the switches S11-Sm1, S12-Sm2, . . . , S1n-Smn in the selected row are turned on, the image data from the data driver 210 is passed to the selected row of display elements D11-Dm1, D12-Dm2, . . . , D1n-Dmn.

During operation, the gate driver 220 can provide a voltage signal via one of the gate lines GL1-GLn to the gates of the switches S11-Smn in a selected row, thereby turning on the switches S11-Smn. After the data driver 210 provides image data to all of the data lines DL1-DLm, the switches S11-Smn of the selected row can be turned on to provide the image data to the selected row of display elements D11-Dm1, D12-Dm2, . . . , D1n-Dmn, thereby displaying a portion of an image. For example, data lines DL that are associated with pixels that are to be actuated in the row can be set to, e.g., 10-volts (could be positive or negative), and data lines DL that are associated with pixels that are to be released in the row can be set to, e.g., 0-volts. Then, the gate line GL for the given row is asserted, turning the switches in that row on, and applying the selected data line voltage to each pixel of that row. This charges and actuates the pixels that have 10-volts applied, and discharges and releases the pixels that have 0-volts applied. Then, the switches S11-Smn can be turned off. The display elements D11-Dm1, D12-Dm2, . . . , D1n-Dmn can hold the image data because the charge on the actuated pixels will be retained when the switches are off, except for some leakage through insulators and the off state switch. Generally, this leakage is low enough to retain the image data on the pixels until another set of data is written to the row. These steps can be repeated to each succeeding row until all of the rows have been selected and image data has been provided thereto. In the implementation of FIG. 2, the optical stack 16 is grounded at each pixel. In some implementations, this may be accomplished by depositing a continuous optical stack 16 onto the substrate and grounding the entire sheet at the periphery of the deposited layers.

FIG. 3 shows an example of a schematic partial cross-section illustrating one implementation of the structure of the driving circuit and the associated display element of FIG. 2. A portion 201 of the driving circuit array 200 includes the switch S22 at the second column and the second row, and the associated display element D22. In the illustrated implementation, the switch S22 includes a transistor 80. Other switches in the driving circuit array 200 can have the same configuration as the switch S22, or can be configured differently, for example by changing the structure, the polarity, or the material.

FIG. 3 also includes a portion of a display array assembly 110, and a portion of a backplate 120. The portion of the display array assembly 110 includes the display element D22 of FIG. 2. The display element D22 includes a portion of a front substrate 20, a portion of an optical stack 16 formed on the front substrate 20, supports 18 formed on the optical stack 16, a movable reflective layer 14 (or a movable electrode connected to a deformable layer 34) supported by the supports 18, and an interconnect 126 electrically connecting the movable reflective layer 14 to one or more components of the backplate 120.

The portion of the backplate 120 includes the second data line DL2 and the switch S22 of FIG. 2, which are embedded in the backplate 120. The portion of the backplate 120 also includes a first interconnect 128 and a second interconnect 124 at least partially embedded therein. The second data line DL2 extends substantially horizontally through the backplate 120. The switch S22 includes a transistor 80 that has a source 82, a drain 84, a channel 86 between the source 82 and the drain 84, and a gate 88 overlying the channel 86. The transistor 80 can be, e.g., a thin film transistor (TFT) or metal-oxide-semiconductor field effect transistor (MOSFET). The gate of the transistor 80 can be formed by gate line GL2 extending through the backplate 120 perpendicular to data line DL2. The first interconnect 128 electrically couples the second data line DL2 to the source 82 of the transistor 80.

The transistor 80 is coupled to the display element D22 through one or more vias 160 through the backplate 120. The vias 160 are filled with conductive material to provide electrical connection between components (for example, the display element D22) of the display array assembly 110 and components of the backplate 120. In the illustrated implementation, the second interconnect 124 is formed through the via 160, and electrically couples the drain 84 of the transistor 80 to the display array assembly 110. The backplate 120 also can include one or more insulating layers 129 that electrically insulate the foregoing components of the driving circuit array 200.

The optical stack 16 of FIG. 3 is illustrated as three layers, a top dielectric layer described above, a middle partially reflective layer (such as chromium) also described above, and a lower layer including a transparent conductor (such as indium-tin-oxide (ITO)). The common electrode is formed by the ITO layer and can be coupled to ground at the periphery of the display. In some implementations, the optical stack 16 can include more or fewer layers. For example, in some implementations, the optical stack 16 can include one or more insulating or dielectric layers covering one or more conductive layers or a combined conductive/absorptive layer.

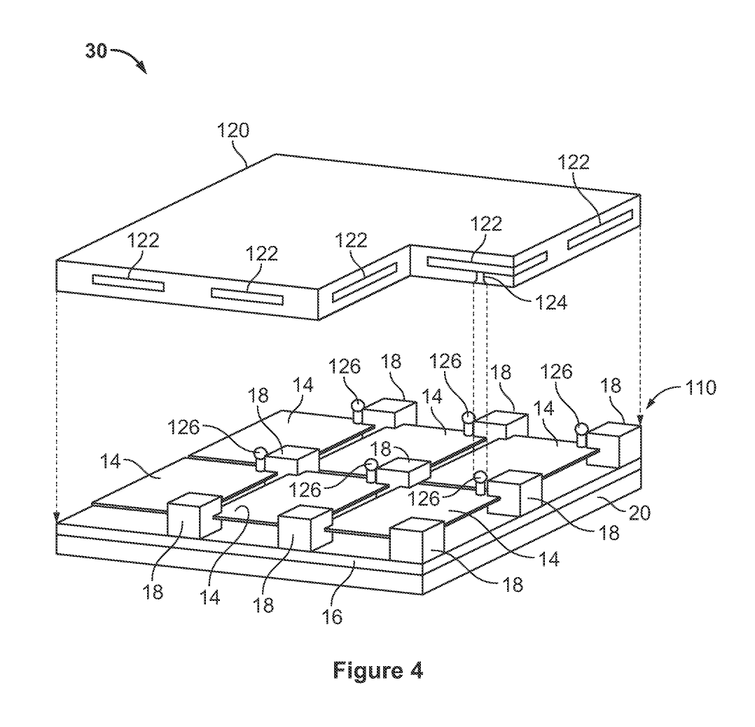

FIG. 4 shows an example of a schematic exploded partial perspective view of an optical MEMS display device 30 having an interferometric modulator array and a backplate with embedded circuitry. The display device 30 includes a display array assembly 110 and a backplate 120. In some implementations, the display array assembly 110 and the backplate 120 can be separately pre-formed before being attached together. In some other implementations, the display device 30 can be fabricated in any suitable manner, such as, by forming components of the backplate 120 over the display array assembly 110 by deposition.

The display array assembly 110 can include a front substrate 20, an optical stack 16, supports 18, a movable reflective layer 14, and interconnects 126. The backplate 120 can include backplate components 122 at least partially embedded therein, and one or more backplate interconnects 124.

The optical stack 16 of the display array assembly 110 can be a substantially continuous layer covering at least the array region of the front substrate 20. The optical stack 16 can include a substantially transparent conductive layer that is electrically connected to ground. The reflective layers 14 can be separate from one another and can have, e.g., a square or rectangular shape. The movable reflective layers 14 can be arranged in a matrix form such that each of the movable reflective layers 14 can form part of a display element. In the implementation illustrated in FIG. 4, the movable reflective layers 14 are supported by the supports 18 at four corners.

Each of the interconnects 126 of the display array assembly 110 serves to electrically couple a respective one of the movable reflective layers 14 to one or more backplate components 122 (e.g., transistors S and/or other circuit elements). In the illustrated implementation, the interconnects 126 of the display array assembly 110 extend from the movable reflective layers 14, and are positioned to contact the backplate interconnects 124. In another implementation, the interconnects 126 of the display array assembly 110 can be at least partially embedded in the supports 18 while being exposed through top surfaces of the supports 18. In such an implementation, the backplate interconnects 124 can be positioned to contact exposed portions of the interconnects 126 of the display array assembly 110. In yet another implementation, the backplate interconnects 124 can extend from the backplate 120 toward the movable reflective layers 14 so as to contact and thereby electrically connect to the movable reflective layers 14.

The interferometric modulators described above have been described as bi-stable elements having a relaxed state and an actuated state. The above and following description, however, also may be used with analog interferometric modulators having a range of states. For example, an analog interferometric modulator can have a red state, a green state, a blue state, a black state and a white state, in addition to other color states. Accordingly, a single interferometric modulator can be configured to have various states with different light reflectance properties over a wide range of the optical spectrum.

The basic design of the active matrix pixels, as discussed above with reference to FIG. 2, may be augmented with additional circuitry to beneficially increase functionality while reducing power consumption. In particular, these pixels can be designed with interconnects so that adjacent pixels can send and receive display data to and from each other, thereby significantly reducing the amount of new content needed to be written from outside the display. Consequently, overall power consumption is also beneficially reduced because writing new data from outside the display is one of the most significant power-consuming tasks of a display. One application that is particularly well suited for interconnected pixels is scrolling of displayed information. Therefore, the following figures will describe implementations where the scrolling function is implemented by sharing data between interconnected pixels, which may reduce overall power consumption of the display during such operations.

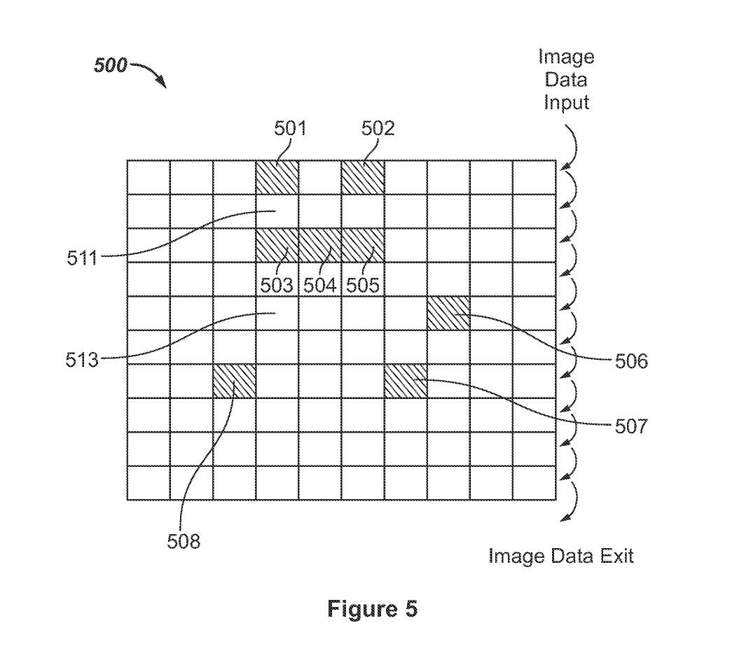

FIG. 5 shows an example diagram of scrolling image data on a display 500. Display 500 includes a plurality of monochromatic pixels (i.e. black or white) in a 10 pixel×10 pixel grid. Pixels 501-508 are all black while the remaining pixels of the display are all white. In this example, each pixel may include a single display element, such as an IMOD. In some other implementations with color displays, each pixel may be made up of a plurality of display elements, such as IMODs, of different colors. In color displays with a plurality of display elements forming a single pixel, each display element may be selectively turned on or off to make a resulting color for the pixel.

In the example shown in FIG. 5, the image data is being scrolled in the downward direction. In one implementation, for each pixel other than those on the top row, image data is being transferred from one pixel to an adjacent pixel, based on the scroll direction, rather than being written to the display again. In this example, the only “new” image data (i.e., data that needs to be written from outside the display) is the image data coming in from the top of the display and into the pixels along the top row of the display. Thus, as the display is scrolled down by one pixel row, the image data in pixel 501 is transferred to pixel 511, the pixel data for pixel 503 is transferred to pixel 513 and so on. Accordingly, by transferring the existing pixel data to adjacent pixels during the scroll operation, instead of completely rewriting the display during each scroll step, significant power savings can be accomplished by transferring pixel data to an adjacent pixel.

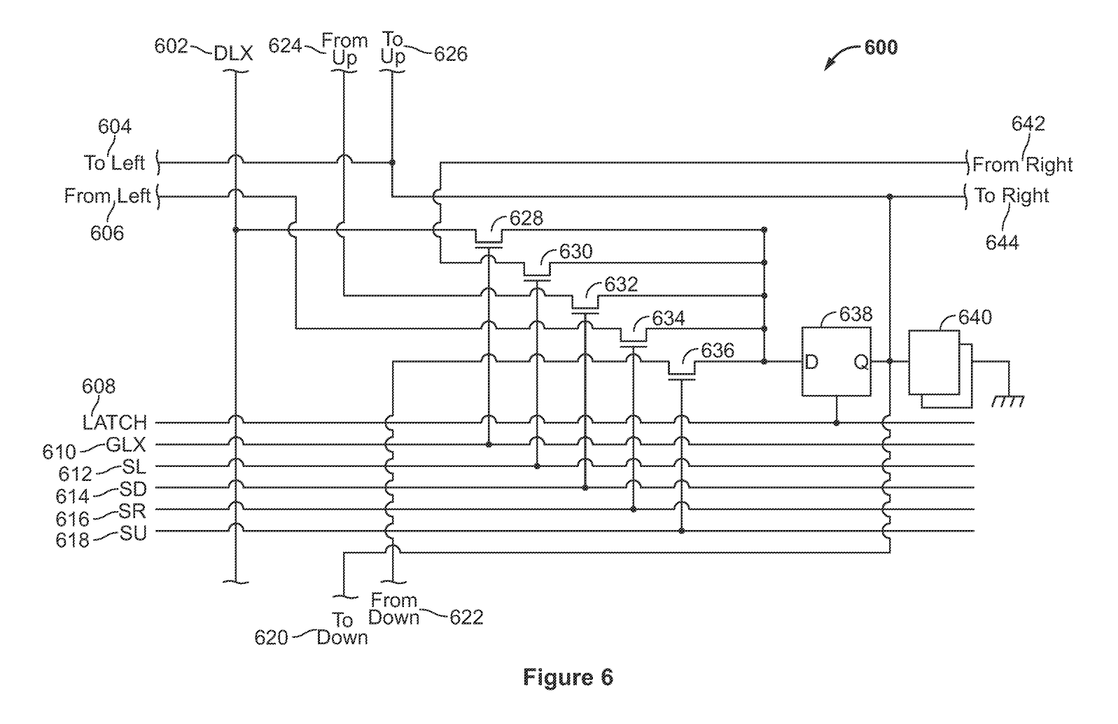

FIG. 6 shows an example of a circuit diagram of a pixel where adjacent pixels are interconnected to allow scrolling in the up, down, left and right directions. Similar to FIG. 5, the implementation of FIG. 6 is of a monochromatic pixel formed with a single display element 640 that can be either black or white. In FIG. 6, the pixel circuitry is augmented with a D-Q type latch 638, also known as a flip-flop memory. A D-Q type latch is a circuit that can be used to store state information such as image data. The output of the D-Q latch remains stable until the assertion of a latch input at which point the input value is moved to the output. Notably, other types of circuits can be used to transfer display data between pixels. Pixel 600 is connected to the adjacent pixel to the left by data interconnect lines 604 and 606; to the adjacent pixel to the top by data interconnect lines 624 and 626; to the adjacent pixel to the right by data interconnect lines 642 and 644; and to the adjacent pixel to the bottom by data interconnect lines 620 and 622. These data lines allow image data to be shared between pixels without the need to write new image data in from outside the display, thereby saving power during certain types of write operations, such as scrolling.

The circuit of FIG. 6 has two primary modes of operation: writing new image data to the display and scrolling image data on the display. To write image data to the display, the circuit works much like that of FIG. 2. First, the display driver writes new image data to each driver data line in the array. In the implementation of FIG. 6, there is one driver data line for each column of pixels in the array. Next, the gate line for the individual row in the array being written is asserted to move the image data on the data lines to the input side of each latch in that particular row. In the implementation of FIG. 6, there is one gate line for each row of pixels in the array. Finally, a latch line for the row being written is asserted to move the data to the output side of each latch and to drive each pixel's display element accordingly. In the implementation of FIG. 6, there is one latch line for each row in the display. Thus, from the perspective of pixel 600 in FIG. 6, new data is written by first putting new image data on driver data line (DLX) 602. Next, gate line (GLX) 610 is asserted to move the image data to the input side of latch 638. Finally, latch line (LATCH) 608 is asserted to move the data to the output side of latch 638 and to drive display element 640 accordingly. Note that the procedure described for pixel 600 is within the context of the rest of the array. Thus, when, for example, gate line 610 and latch 608 are asserted, image data from the data lines DLX will move to the output side of every latch in the row, including latch 638 of pixel 600.

The second primary mode of operation of the circuit in FIG. 6 is to scroll the image data of the entire array. Scroll lines (SL) 612, (SD) 614, (SR) 616 and (SU) 618 may be selectively asserted in order to enable scrolling of the display data in one of the upward, downward, leftward or rightward directions. Note, in some other implementations, there may be additional scroll lines and data interconnect lines to activate, for example, diagonal scrolling. The scroll lines 612, 614, 616 and 618 may be connected in parallel to each pixel in the array so that the entire display can be placed in a particular scroll mode, such as up, down, left or right. For example, to scroll the entire screen up one pixel, scroll line 618, which is connected as shown in common to all pixels in the array, is asserted, which causes switches in the array to activate and interconnect the latches of adjacent pixels in the scroll direction. Next, the latch lines for each row in the array are asserted simultaneously to move the image data between interconnected pixels in the scroll direction and drive each interconnected pixel's display element accordingly. The following are examples of scrolling operations from the perspective of pixel 600.

As a first example, consider the case in which the scroll direction is up and pixel 600 is not on the bottom row of the display. Because the scroll direction is up, image data may be transferred from the pixel below and adjacent to pixel 600. Accordingly, data line 622, which is connected to the output of the latch of the pixel below and immediately adjacent to pixel 600 (not shown), is connected to the input side of latch 638 by asserting scroll line 618. Asserting scroll line 618 activates switch 636 and transfers the image data from the output side of the below pixel's latch to the input side of latch 638. Next, latch line 608 is asserted so that the image data is switched to the output side of latch 638, which drives display element 640 accordingly. Thus, if pixel 600 was white and the pixel below was black, after the above operation pixel 600 would be black. Note that, as above, the procedure described for pixel 600 is within the context of the rest of the array. Thus, for example, latch line 608 is asserted for all the rows of the array simultaneously, causing image data to be transferred from each pixel in the array to each corresponding pixel in the row above.

As another example, consider the case in which the scroll direction is down and pixel 600 is not on the top row of the display. Because the scroll direction is down, image data may be transferred from the pixel above and adjacent to pixel 600. Accordingly, data line 624, which is connected to the output of the latch of the pixel above and immediately adjacent to pixel 600 (not shown), is connected to the input side of latch 638 by asserting scroll line 614. Asserting scroll line 614 activates switch 632 and transfers the image data from the output side of the above pixel's latch to the input side of latch 638. Next, latch line 608 is asserted so that the image data is switched to the output side of latch 638, which drives display element 640 accordingly. Thus, if pixel 600 was white and the pixel above was black, after the above operation pixel 600 would be black.

As yet another example, consider the case in which the scroll direction is right and pixel 600 is not on the left-most column of the display screen. Because the scroll direction is right, image data may be transferred from the pixel to the left and adjacent to pixel 600. Accordingly, data line 606, which is connected to the output of the latch of the pixel to the left and immediately adjacent to pixel 600 (not shown), is connected to the input side of latch 638 by asserting scroll line 616. Asserting scroll line 616 activates switch 634 and transfers the image data from the output side of the pixel to the left's latch to the input side of latch 638. Next, latch line 608 is asserted so that the image data is switched to the output side of latch 638, which drives display element 640 accordingly. Thus, if pixel 600 was white and the pixel to the left was black, after the above operation pixel 600 would be black.

As a further example, consider the case in which the scroll direction is left and pixel 600 is not on the right-most column of the display screen. Because the scroll direction is left, image data may be transferred from the pixel to the right and adjacent to pixel 600. Accordingly, data line 642, which is connected to the output of the latch of the pixel to the right and immediately adjacent to pixel 600 (not shown), is connected to the input side of latch 638 by asserting scroll line 612. Asserting scroll line 612 activates switch 630 and transfers the image data from the output side of the pixel to the right's latch to the input side of latch 638. Next, latch line 608 is asserted so that the image data is switched to the output side of latch 638, which drives display element 640 accordingly. Thus, if pixel 600 was white and the pixel to the right was black, after the above operation pixel 600 would be black.

Special considerations may be made when scrolling image data at the edge of a display, where, depending on the scroll direction there may be no adjacent pixel. Consider the situation where the scroll direction is down and pixel 600 is in the top row of the array. Because pixel 600 is in the top row, there is no adjacent image data to transfer because there is no adjacent pixel above pixel 600. In such a case, data line 624, which for other pixels in the array may be tied to the pixel above, can instead be tied to the data driver itself. Thus, the procedure would be the same as the above, except that asserting scroll line 614 would connect pixel 600 (and all other pixels in the top row) to the data driver so that new image data would be moved to the input side of latch 638. The same configuration will work for scrolling up, where pixel 600 is on the bottom row of the display, except that data line 622 would be connected to the data driver.

An alternative method for handling edge scrolling in the upward or downward direction is to simply scroll all of the data on the display except for the affected edge (i.e., the edge where there is no adjacent pixel data), and then write one new row of data to the edge row using conventional data writing techniques. The new row of data could be written to the top row or the bottom row based on the scroll direction.

Now consider the situation where the scroll direction is to the right and pixel 600 is in the left-most column of the display. Because pixel 600 is in the left-most column, there is no adjacent image data to transfer because there is no adjacent pixel to the left of pixel 600. Accordingly, new data needs to be written to the pixel. As above, the interconnect that would normally connect pixel 600 to the adjacent pixel to the left could instead be connected to the data driver. For example, if pixel 600 is in the left-most column of the array and the scroll direction is right, interconnect line 606 may be connected to the display driver so that when scroll line 616 is asserted, new data may be placed on the input side of latch 638. The same configuration will work for scrolling to the left, where pixel 600 is in the right-most column of the display, except that data line 642 would be connected to the data driver.

The configuration shown in FIG. 6 allows scrolling of the entire display in four directions (up, down, left, right) for monochromatic pixels. In a color display, it is common for pixel rows to be dedicated to display elements of a given color. For example, the rows of the display may include sets of red, green, and blue rows of display elements. In these cases, scrolling involves moving the data multiple steps for each scroll jump. This may be done with the connections in FIG. 6 by asserting the latch signal multiple times for each scroll step. Alternatively, the connections between display elements could jump multiple steps to connect the correctly corresponding pixels.

As an example of this display system of FIG. 6 in operation, a smartphone with a touch screen may be considered. During some display operations, for example, as the user is touching icons on the screen to launch programs, dial phone numbers, etc., none of the scroll lines 612-618 are asserted, and the system operates by writing new data to all the pixels from outside the display for each frame. If the user swipes the screen left, this is interpreted as a scroll left command, and scroll line 612 is asserted to put the display in scroll left mode. Then, the latch line 608 is asserted a series of times causing the image on the display to scroll to the left while inputting new image information only into the first column on the right side of the display.

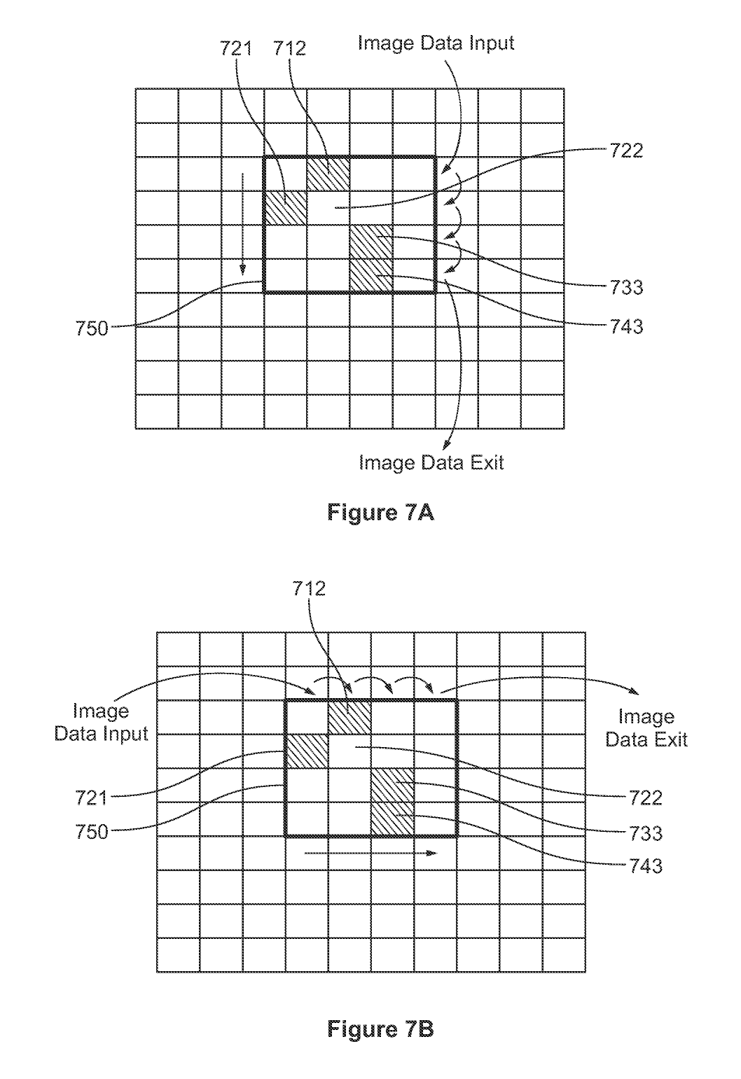

There may be situations in which it is desirable to only scroll an area within the display, and not the entire display content, while retaining the benefits described above. For ease, this area will be referred to as the “scroll area.” FIGS. 7A and 7B show examples of image data for selected scroll areas of a display, including selected rows and columns, being scrolled. In FIG. 7A, as depicted by the arrow, the scroll direction is down. Thus, here, as with FIG. 5, the only new image data being written to scroll area 750 is the image data coming in from the top. For example, if the scroll area is scrolled down, the image data for pixel 722 will be replaced by the image data of pixel 712 upon scrolling one pixel. Pixel 712 will have new image data written to it from outside the display by the display driver since there is no adjacent pixel above pixel 712 within the scroll area. FIG. 7A is different from FIG. 5 in that the scroll area is only a portion of the total display area. However, for the same reasons as previously described, it is more power efficient to update the selected scroll area by transferring image data already on the display between adjacent pixels and only writing new image data from outside the display for the top row of pixels.

In FIG. 7B, as depicted by the arrow, the scroll direction is to the right. Thus, here the only “new” image data being written to scroll area 750 is the image data coming in from the left. For example, if the scroll area is scrolled right, the image data for pixel 722 will be replaced by the image data of pixel 721 upon scrolling one pixel. Pixel 721 will have new image data written to it from outside the display by the display driver since there is no adjacent pixel to the left of pixel 721 within the scroll area.

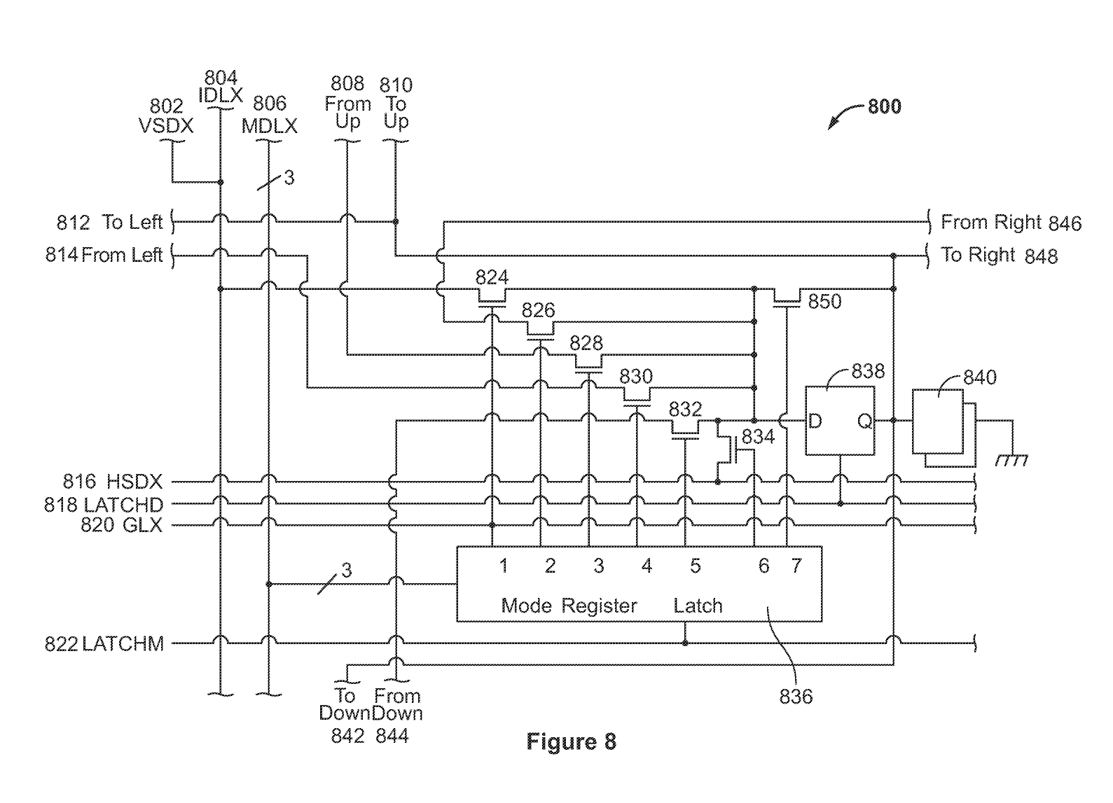

FIG. 8 shows an example of a circuit diagram of a pixel 800 where adjacent pixels are interconnected to allow scrolling in the up, down, left and right directions. The implementation of FIG. 8 is capable of scrolling the entire display or just a scroll an area within the display. Similar to FIGS. 5 and 6, the implementation of FIG. 8 is of a monochromatic pixel formed with a single display element 840 that can be either black or white. In FIG. 8, the pixel circuitry is augmented with a D-Q type latch 838 as well as a mode register 836. The mode register 836 allows the selection of eight different pixel modes for each pixel with three input lines from mode register bus (MDLX) 806. Pixel 800 is connected: to the adjacent pixel to the left by data interconnect lines 812 and 814; to the adjacent pixel to the top by data interconnect lines 808 and 810; to the adjacent pixel to the right by data interconnect lines 846 and 848; and to the adjacent pixel to the bottom by data interconnect lines 842 and 844. These data interconnect lines allow image data to be shared between pixels without the need to write new image data in from outside the display, thereby saving power during certain types of write operations, such as scrolling.

Scrolling a certain “scroll area” within the total display area using data from adjoining pixels is more complicated that scrolling the entire screen. Accordingly, mode register 836, vertical scroll data line (VSDX) 802 and horizontal scroll data line (HSDX) 816 allow for increased scroll functionality. The four primary tasks of the circuit depicted in FIG. 8 are to write new image data to display from outside the display, to scroll the entire display, to scroll image data between adjacent pixels within a scroll area, and to write new data into the scroll area where a pixel is on the edge of the scroll area (which may be on the edge of the whole display).

In the implementation of FIG. 8, the mode register allows a selection of a data input mode for each pixel prior to a frame update. When the display is being used in normal mode, where new image information is being written to the display, the mode registers are written data that turns each of the mode register outputs off. The mode registers can be written in row-by-row fashion similar to writing image data. To write data to the mode registers, the mode data lines 806 for each column are set to the desired value for each register along a given row. Then the mode latch line (LATCHM) 822 for the given row is asserted to latch the data into the registers. This is repeated row-by-row, allowing independent control of the mode for each pixel of the array. This process also can be performed when the array enters a scroll mode. The data written to each pixel's mode register (e.g., 836) determines which switch is closed, which determines the source of image data for each pixel. Therefore, when entering a scroll mode, the data written to the mode registers of the array will define the scroll direction and the size, shape, and position of the scroll area.

Writing new image data to a display including pixels such as that in FIG. 8 is done in much the same way as that described in FIG. 2. That is, for each row of image data, the data driver first writes the image data to the respective driver data lines for each pixel in the row. Next, the gate line for the current row is asserted to move the data to the input side of each pixel's latch. In the implementation of FIG. 8, there is a driver data line (designated IDLX 804 and described further below) for every column of pixels in the display and a gate line (designated GLX 820 and described further below) for every row of pixels in the display. Finally, the data latch line for the current row is asserted to move the image data from the input side of each pixel's latch to the output side of each pixel's latch, which then drives each pixel's display element accordingly. This procedure is repeated for each row in the display. Thus, from the perspective of pixel 800, new image data is first written by the data driver to driver data line (IDLX) 804. Next, gate line (GLX) 820 is asserted to activate switch 824, which causes the new image data to move to the input side of latch 838. Finally, latch line (LATCHD) 818 is asserted to move the image data to the output side of latch 838, which drives display element 840 accordingly. As noted above, when writing new frames of image data to the entire display, the mode registers are previously set so that all seven outputs are off.

In order to scroll the entire display, the mode registers are used to connect adjacent pixels to each other. For example, to scroll the entire display up, the data driver writes mode selection data into each mode register for each pixel in the display that turns output 5 of each mode register on. When each pixel is connected to the pixel below it, the image data moves from the output side of the below pixel's latch to the input side of the above pixel's latch. Then, the data latch lines for all rows of the array are asserted to move the image data to the output side of each pixel and to drive each display element in the row accordingly. Thus, from the perspective of pixel 800, when the whole display is scrolled up by one pixel, the data driver first writes mode selection data onto mode data bus 806. Next, mode latch line 822 is asserted to write the mode selection data into the mode register, which then causes the selection of mode line 5 and activates switch 832. When switch 832 is activated, image data moves from the output side of the below pixel's latch to the input side of latch 838. Finally, data latch line 818 is asserted, which moves the image data to the output side of latch 838 and drives display element 840 accordingly. Note, again, that this procedure is completed within the context of the entire display. Thus, for example, when data latch line 818 is asserted, it causes data to move from each pixel in the row below to its corresponding pixel in the row above.

In order to scroll image data between adjacent pixels within a scroll area, the mode registers are used to define the scroll area and set the scroll behavior of every pixel in the display accordingly. For pixels not within the scroll area, the data driver writes mode selection data into the mode registers for these pixels to connect the output of each of these pixels' latch to its own input, effectively copying the current image data back to the input side of the latch. Then, when the data latch line is asserted, the image data moves to the output side of each pixel's latch and the display elements are driven accordingly. Because the new image data is a copy of the previous image data, the pixel does not change state. Thus, from the perspective of pixel 800, where pixel 800 is not in any scroll area, the data driver first writes mode selection data to mode data bus 806. Next, mode latch line 822 is asserted to write the mode selection data into mode register 836. When the mode selection data is written to mode register 836, mode register line 7 is asserted and switch 850 is activated. When switch 850 is activated, the output side of latch 838 is connected to its own input side, which transfers the current image data to the input side of the latch. Finally, when data latch line 818 is asserted, the image data moves from the input side to the output side of latch 838 and drives display element accordingly. However, since the image data is a copy of the previous image data, the state of display element 840 does not change.

For a pixel within the scroll area, the same procedure is completed except that for pixels within the scroll area, the mode selection data is configured to connect each pixel within the scroll area to an appropriate adjacent pixel instead of to itself. In this way, the scroll area can be selectively defined by initially writing the appropriate data to the mode registers.

As a first example, to scroll image data up to pixel 800, where pixel 800 is within the scroll area, image data may be transferred from the pixel below and adjacent to pixel 800. Thus, data is written to mode register 836 to select mode register output 5 and activate switch 832. When switch 832 is activated, the output side of the latch from the pixel below and adjacent to pixel 800 (not shown) is connected to the input side of latch 838, and the image data from the pixel below is transferred to the input side of latch 838 via data interconnect line 844. Finally, data latch line 818 is asserted such that the image data moves to the output side of latch 838 and drives display element 840 accordingly. Thus, if pixel 800 was white and the pixel below was black, after the above operation pixel 800 would be black. Note, again, that this procedure is completed within the context of the entire display. Thus, for example, when data latch line 818 is asserted, it causes data to move for each pixel in the array (including pixel 800) according to the mode selected for each pixel.

A scroll area may have a row or column that needs new data written in from outside of the display during scroll operations. For example, if the scroll direction is up, the bottom row of the scroll area will need new data because there is no adjacent pixel to share image data with. Accordingly, vertical scroll data line 802 and horizontal scroll data line 816 are implemented to provide new image data for edge pixels of a scroll area. In the implementation of FIG. 8, there is a vertical scroll data line for each column in the display and a horizontal scroll data line for each row in the display. Thus, to write new data to the bottom row of a scroll area when the scroll direction is up, the same procedure as described for scrolling data within a scroll area (above) is completed, except that for pixels along the bottom row of the scroll area, the data driver, rather than an adjacent pixel, provides new image data via the vertical scroll data line of each pixel in the bottom row of the scroll area. Accordingly, from the perspective of pixel 800, where pixel 800 is on the bottom row of a scroll area and the scroll direction is up, the data driver first writes the mode selection data into mode register 836 to activate switch 824. When switch 824 is activated, the new image data on the vertical scroll data line (VSDX) 802 is transferred to the input side of latch 838. Finally, data latch line 818 is asserted so that the image data moves to the output side of latch 838 and drives display element 840 accordingly. This same procedure may be used where the scroll direction is down and pixel 800 is in the top row of the scroll area since the vertical scroll data line may just as easily provide image data for the top as the bottom of the scroll area.

As another example, if the scroll direction is left, then the right-most column of the scroll area will need new data because there is no adjacent pixel to share image data with. Thus, to write new data to the right-most column of a scroll area when the scroll direction is left, the same procedure as described for scrolling data within a scroll area (above) is completed, except that for pixels along the right-most column of the scroll area, the data driver, rather than an adjacent pixel, provides new image data via the horizontal scroll data line of each pixel in the right-most column of the scroll area. Accordingly, from the perspective of pixel 800, where pixel 800 is located at the right edge of a scroll are and the scroll direction is left, the data driver writes new image data onto horizontal scroll data line 816. Next, an appropriate signal is asserted on mode data bus 806 to select mode register line 6. Next, mode latch line 822 is asserted, which transfers the mode selection data into mode register 836 and activates switch 834. When switch 834 is activated, the new image data on the horizontal scroll data line 816 is transferred to the input side of latch 838. Finally, data latch line 818 is asserted such that the image data moves to the output side of latch 838 and drives display element 840 accordingly. This same procedure may be used where the scroll direction is to the right and pixel 800 is in the left-most column of the scroll area since the horizontal scroll data line may just as easily provide image data for the left as the right of the scroll area.

As an example of this display system of FIG. 8 in operation, a smartphone with a touch screen also may be considered. During some display operations, for example, as the user is touching icons on the screen to launch programs, dial phone numbers, etc., the mode registers for each pixel are configured such that all of the mode register outputs are off, and the system operates by writing new data to all the pixels from outside the display for each frame. If the user swipes the screen left on a pre-defined window portion of the display, this may be interpreted as a scroll left command within that window, where other display pixels are static. When this command is interpreted, the display driver writes the appropriate values to the mode registers of the array to perform the desired action. In this case, mode registers for pixels outside the scroll window could be written with [111] to assert output 7, which ties the input of the latch to its own output. Pixels within the scroll window, except the rightmost column within the scroll window, are written with [010] to assert output 2, which connects these pixels to the pixel on their right. Pixels in the rightmost column of the scroll window have their mode register written with [110] to assert output 6, which connects these pixels to the driver outside the display for receipt of new image data on the right as the existing data moves left. Then, the latch line 818 is asserted a series of times causing the image within the scroll window on the display to scroll to the left while inputting new image information only into the first column on the right side of the display and while the remainder of the pixels of the display remain static.

It is important to note that the mode registers for a range of pixels belonging to a specified scroll region may be written substantially simultaneously, thus maintaining the power and speed advantage of particular implementations of the subject matter described in this disclosure. For example, for a rectangular scroll area (FIG. 7A and 7B), the LATCHM line 822 may be asserted for all the scan lines intersecting with the scroll area simultaneously, and MDLX bus 806 may be used to send appropriate data to define the vertical boundaries of this region. Using non-rectangular scroll regions can likewise be done as would be apparent to a person having ordinary skill in the art.

Another method of implementing a defined scroll area within the total display area would be to define fixed scroll regions within the display. In this case, the value that would have been put into the mode register can be substantially fixed at design time. Methods of constant propagation well known to persons having ordinary skill in the art may then be deployed to eliminate redundant parts of the circuit. For example, if the mode register can take only one of three values corresponding to scroll down, up, and for using data from the driver (corresponding to mode register outputs 3, 4, and 1 respectively in FIG. 8), then switches 826, 832, 834 and 850 may be eliminated together with the corresponding outputs of the mode register (2, 5, 6, 7 respectively).

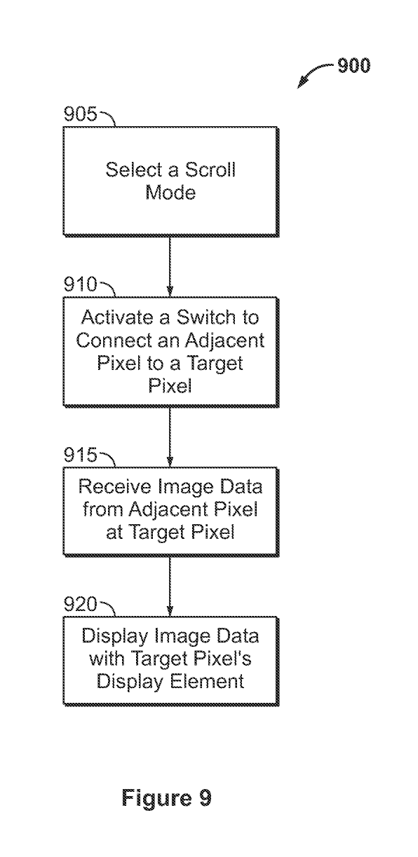

FIG. 9 shows an example of a method 900 of scrolling image data from a first pixel to a target pixel. Starting with block 905, a scroll mode for a target pixel is selected. The scroll mode may be selected as described above with reference to FIG. 6 or 8. Next, at block 910, a switch is activated to connect the first pixel to a target pixel so that image data may be shared between the two pixels. At block 915, the target pixel receives image data from the first pixel according to the scroll mode. Finally, at block 920, the target pixel displays the image data by driving its display element accordingly.

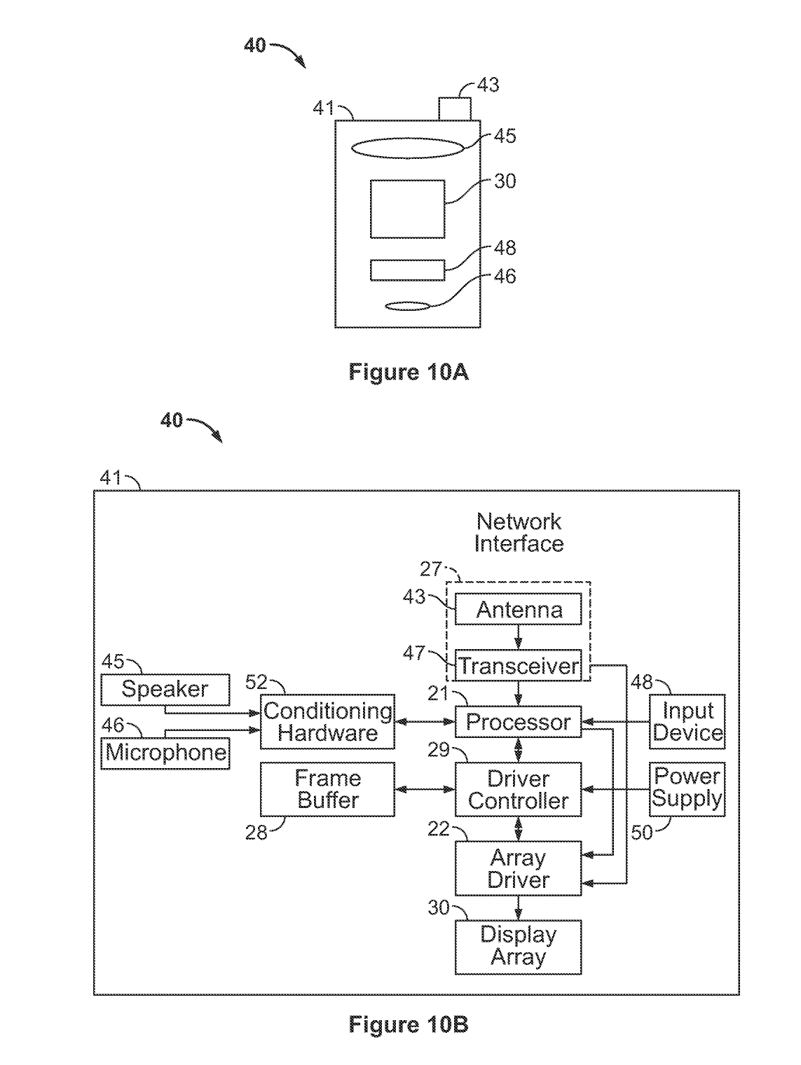

FIGS. 10A and 10B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 10B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

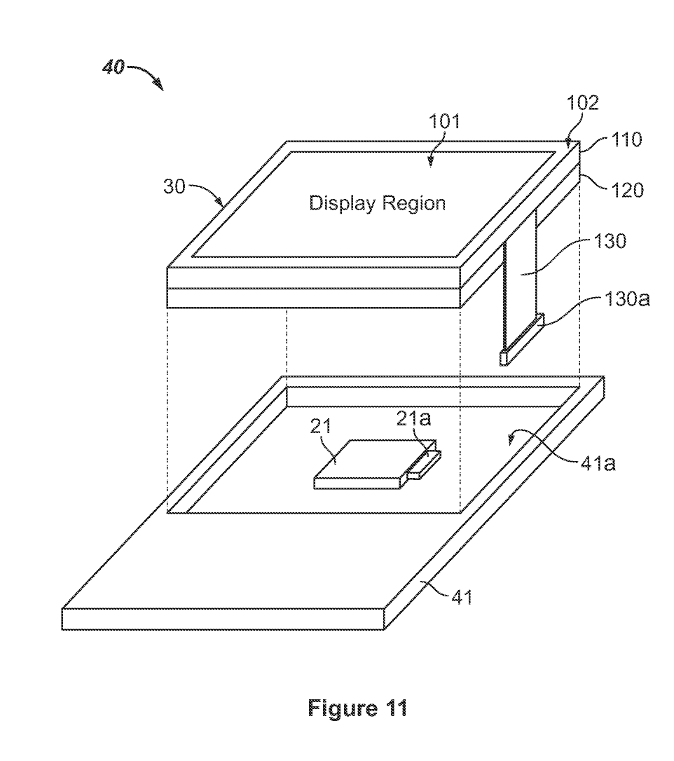

FIG. 11 shows an example of a schematic exploded perspective view of an electronic device 40 having an optical MEMS display. In some implementations, the electronic device 40 can be the electronic device 40 depicted in FIGS. 10A and 10B. The illustrated electronic device 40 includes a housing 41 that has a recess 41 a for a display array 30. The electronic device 40 also includes a processor 21 on the bottom of the recess 41a of the housing 41. The processor 21 can include a connector 21 a for data communication with the display array 30. The electronic device 40 also can include other components, at least a portion of which is inside the housing 41. The other components can include, but are not limited to, a networking interface, a driver controller, an input device, a power supply, conditioning hardware, a frame buffer, a speaker, and a microphone, as described earlier in connection with FIG. 10B.

The display array 30 can include a display array assembly 110, a backplate 120, and a flexible electrical cable 130. The display array assembly 110 and the backplate 120 can be attached to each other, using, for example, a sealant.

The display array assembly 110 can include a display region 101 and a peripheral region 102. The peripheral region 102 surrounds the display region 101 when viewed from above the display array assembly 110. The display array assembly 110 also includes an array of display elements positioned and oriented to display images through the display region 101. The display elements can be arranged in a matrix form. In some implementations, each of the display elements can be an interferometric modulator. Also, in some implementations, the term “display element” may be referred to as a “pixel.”

The backplate 120 may cover substantially the entire back surface of the display array assembly 110. The backplate 120 can be formed from, for example, glass, a polymeric material, a metallic material, a ceramic material, a semiconductor material, or a combination of two or more of the foregoing materials, in addition to other similar materials. The backplate 120 can include one or more layers of the same or different materials. The backplate 120 also can include various components at least partially embedded therein or mounted thereon. Examples of such components include, but are not limited to, a driver controller, array drivers (for example, a data driver and a scan driver), routing lines (for example, data lines and gate lines), switching circuits, processors (for example, an image data processing processor) and interconnects.

The flexible electrical cable 130 serves to provide data communication channels between the display array 30 and other components (for example, the processor 21) of the electronic device 40. The flexible electrical cable 130 can extend from one or more components of the display array assembly 110, or from the backplate 120. The flexible electrical cable 130 can include a plurality of conductive wires extending parallel to one another, and a connector 130a that can be connected to the connector 21a of the processor 21 or any other component of the electronic device 40.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
an array of pixels, wherein each pixel includes at least one of a display element and a memory element;
one or more data interconnect lines connecting a first pixel to one or more other pixels;
one or more switches positioned in one or more of the interconnect lines; and
one or more scroll data lines connected to one or more of the switches.

2. The display device of claim 1, wherein the display element includes an interferometric modulator (IMOD).

3. The display device of claim 1, wherein the memory element includes a latch.

4. The display device of claim 1, wherein at least one other pixel is adjacent to the first pixel.

5. The display device of claim 1, further comprising:
a display;
a processor that is configured to communicate with the display, the processor being configured to process image data; and
a memory device that is configured to communicate with the processor.

6. The display device of claim 5, further comprising:
a driver circuit configured to send at least one signal to the display.

7. The display device of claim 6, further comprising:
a controller configured to send at least a portion of the image data to the driver circuit.

8. The display device of claim 5, further comprising:
an image source module configured to send the image data to the processor.

9. The display device of claim 8, wherein the image source module includes at least one of a receiver, transceiver, and transmitter.

10. The display device of claim 5, further comprising:
an input device configured to receive input data and to communicate the input data to the processor.

11. A display device comprising:
means for connecting a first pixel to a target pixel;
means for receiving image data from the first pixel at the target pixel; and
means for displaying the image data with the target pixel.

12. The display device of claim 11, wherein the means for connecting a first pixel to a target pixel includes a switch.

13. The display device of claim 11, wherein the means for receiving image data from the pixel at the target pixel includes one or more data interconnect lines.

14. The display device of claim 11, wherein the means for displaying the image data with the target pixel includes a display element.

15. The display device of claim 14, wherein the display device is an IMOD.

16. A method of scrolling image data from a first pixel to a target pixel, the method comprising:
connecting the first pixel to the target pixel;
receiving image data from the first pixel at the target pixel; and
displaying the image data at the target pixel.

17. The method of claim 16, further comprising:
receiving scroll mode data at the target pixel.

18. The method of claim 16, further comprising:
writing new data to the first pixel when the first pixel is on the edge of a scroll area.

19. The method of claim 16, further comprising:
connecting the first pixel to the second pixel;
receiving image data from the second pixel at the first pixel; and
displaying the image data at the first pixel.
